(19) United States
(12) Patent Application Publication
(10) Pub. No.: US 2006/0101331 A1
(43) Pub. Date: May 11, 2006

(54) Methods and systems for automated test-case generation

(75) Inventors: Farn Wang, Taipei City (TW); Jian-Ming Wang, Qingshui Township (TW); An-Yi Chen, Hsinchu City (TW); Chiu-Han Hsiao, Keelung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Institute for Information Industry

(21) Appl. No.: 11/034,698

(22) Filed: Jan. 13, 2005

(30) Foreign Application Priority Data
Nov. 5, 2004 (TW) 93133830

(51) Int. Cl. G06F 17/21

(52) U.S. Cl. 715/513; 715/523

(57) ABSTRACT

A method for automated test-case generation. A first type SDL is translated to a second type SDL in accordance with translation rules. The second type SDL is analyzed using a coverage analysis algorithm for calculating the coverage of the second type SDL, and test cases corresponding to the second type SDL are generated according to the coverage. Test cases complying with tree and tabular combined notation (TTCN) formats are generated according to a tree structure corresponding to the second type SDL and TTCNs.

### BACKGROUND

The invention relates to methods for data generation, and more particularly, to methods for automated test-case generation.

A software development cycle typically comprises definition, design, development, testing, deployment, and management. Applications must be tested to verify reliability, functionality, and performance.

Communication protocol applications are designed using unified modeling languages (UML) and specification and descriptive languages (SDLs). SDLs are standard languages describing finite state machine (FSM) systems and communication network protocol description and development, acknowledged by the International Telecommunication Union (ITU).

Verification of communication protocol applications can be implemented using software packages collocating self-designed test cases. These public software packages provide simple function tools but not verifications, due to complicated design and a large amount of data transmission for communication protocol applications.

Test cases for communication protocol applications can be also designed using either standard SDLs or others for verification. If communication protocol applications are to be verified using verification tools compatible with other SDLs, standard SDLs must be manually translated to specific SDLs. The manual translation, however, easily causes problems because of inappropriate synthetic operations, thus requiring more test time and manpower for accuracy of translation checking.

Additionally, current test systems cannot automatically generate test cases. Conventional verification of developed communication protocol applications is implemented progressively via manually designed test cases, ignoring some test conditions due to subjective concerns or insufficient consideration, changing validity of verification processes and accuracy of results. Reliable test cases require design capability, time, effort, and capital.

Thus, a method for automatically translating SDLs and generating test cases is desirable.

### SUMMARY

Methods for automated test-case generation are provided. In an embodiment of such a method, the first type SDL is translated to a second type SDL in accordance with translation rules. The second type SDL is analyzed using a coverage analysis algorithm for calculating the coverage of the second type SDL, and test cases corresponding thereto are generated according to the coverage. Test cases complying with tree and tabular combined notation (TTCN) formats are generated according to a tree structure corresponding to the second type SDL and TTCNs.

Also disclosed are systems for automated test-case generation. An embodiment of such a system comprises a language translation module, a coverage analysis module, and a test-case generation module. The language translating module translates the first type SDL to a second type SDL in accordance with translation rules. The coverage analysis module analyzes the second type SDL using a coverage analysis algorithm to calculate coverage of the second type SDL, and generates test cases corresponding to the second type SDL according to the coverage. The test-case generation module generates test cases complying with tree and tabular combined notation (TTCN) formats according to a tree structure corresponding to the second type SDL and TTCNs.

### BRIEF DESCRIPTION OF THE DRAWINGS

The invention can be more fully understood by reading the subsequent detailed description and examples of embodiments thereof with reference made to the accompanying drawings, wherein:

FIG. 1 is a schematic view of an embodiment of a system for automated test-case generation;

FIG. 2 is a schematic view of an embodiment of a SDL translation module of the system;

FIG. 3 is a schematic view of an embodiment of a graphic interface representing a SDL;

FIG. 4 is a schematic view of an embodiment of a coverage analysis module of the system;

FIG. 5 is a schematic view of an embodiment of a tree structure corresponding to a test case;

FIG. 6 is a schematic view of an embodiment of a tree structure representing coverage of a SDL;

FIG. 7 is a flowchart of an embodiment of generating a TTCN format test case;

FIG. 8 is a flowchart of an embodiment of generating parameters from a dynamic part in a TTCN format test case; and

FIG. 9 is a flowchart of an embodiment of a method for automated test-case generation.

### DETAILED DESCRIPTION

Embodiments of the invention disclose systems and methods for automated test-case generation.

Embodiments of the invention create models for automated test-case generation, assisting in generation of automated test cases and development of high-level description languages and automated verification models, applied in automatic analysis and critical test-case generation, thereby obtaining maximum coverage. Additionally, embodiments of the invention translate standard specification and description languages (SDLs) to specific SDLs complying with region-encoding diagram (RED) standards, and utilize a RED verification tool to generate test cases for verifying developed communication protocol applications. The RED verification tool is an integrated tool for model verification and simulation, verifying timed automata based on a clock-restriction diagram (CRD) and linear hybrid automata based on a hybrid-restriction diagram (HRD). Additionally, the RED verification tool provides graphic user interfaces, auto-generated counters, and deadlock detection functions.

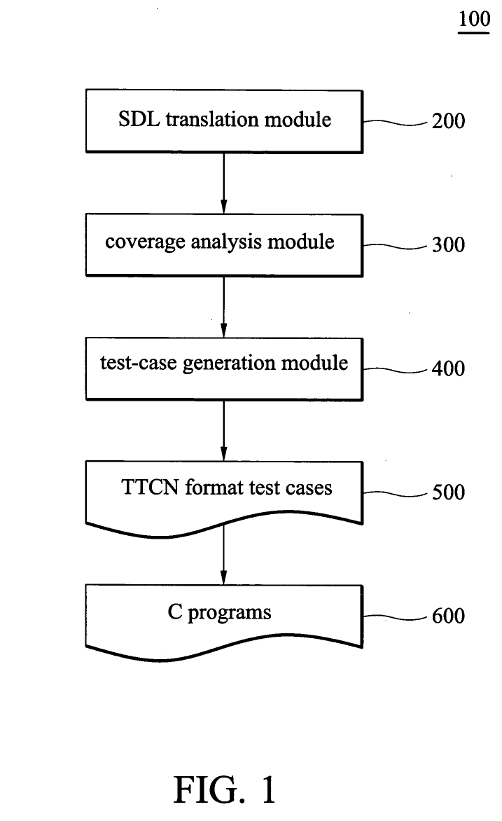

FIG. 1 is a schematic view of an embodiment of a system for automated test-case generation. A system 100 comprises a SDL translation module 200, a coverage analysis module 300, and a test-case generation module 400.

SDL translation module 200 translates a standard SDL to data readable for coverage analysis module 300 according to translation rules, defining differences between semantics of the standard SDL and a translation method. The data records a specific SDL required during analysis processes for coverage analysis module 300. Additionally, the translation rules can be modified, such that SDL translation module 200 can translate a standard SDL to comply with other verification standards.

Coverage analysis module 300 analyzes and verifies the translated SDL to calculate coverage thereof.

Test-case generation module 400 generates tabular combined notation (TTCN) format test cases corresponding to the translated SDL according to analysis and verification results of coverage analysis module 300.

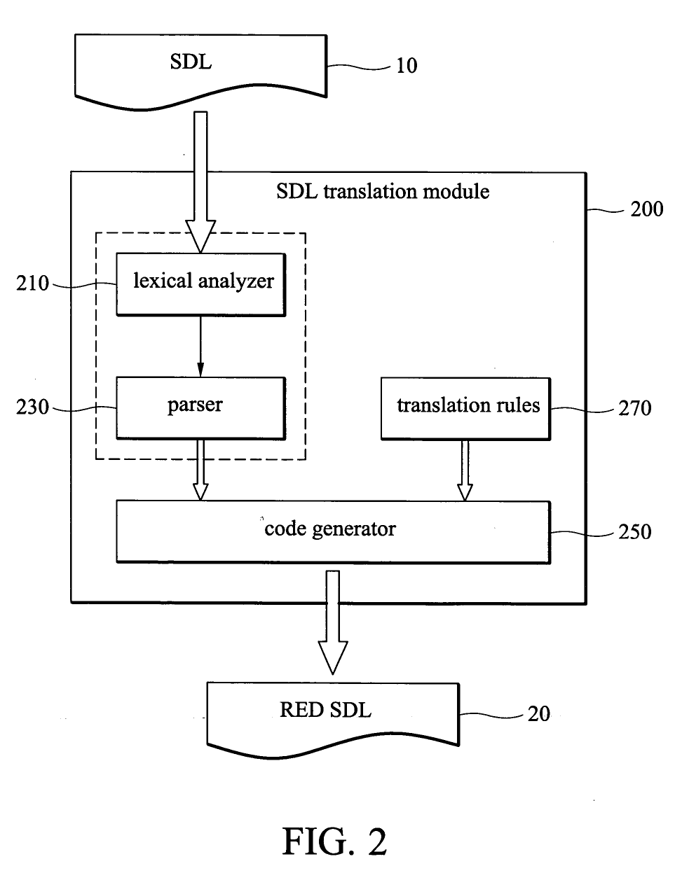

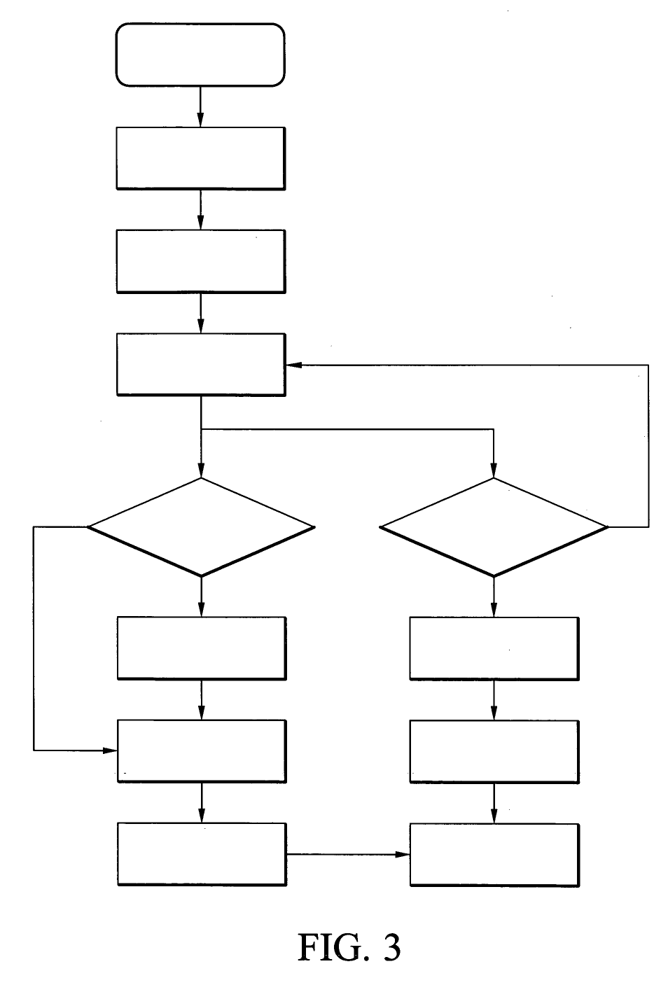

FIG. 2 is a schematic view of an embodiment of SDL translation module 200 of system 100. SDL translation module 200 comprises a lexical analyzer 210, a parser 230, and a code generator 250. Lexical analyzer 210 implements lexical analysis in a system structure designed in accordance with a SDL 10. A SDL describes interactions between modules in a communication protocol system and graphically describes state/message behavior of the modules. Referring to FIG. 3, for example, interactions between SDL modules are represented by a plurality of blocks, each block indicating an operation, such that SDL 10 can be represented by operational blocks. To implement lexical analysis, lexical analyzer 210 first translates a graphically represented SDL to a textually represented SDL.

Parser 230 retrieves, from lexical analysis results, a SDL applicable to coverage analysis. Code generator 250 translates the SDL complying with RED verification tool applicable to the coverage analysis to state spaces and then generates codes corresponding to the state spaces, the codes stored in a register.

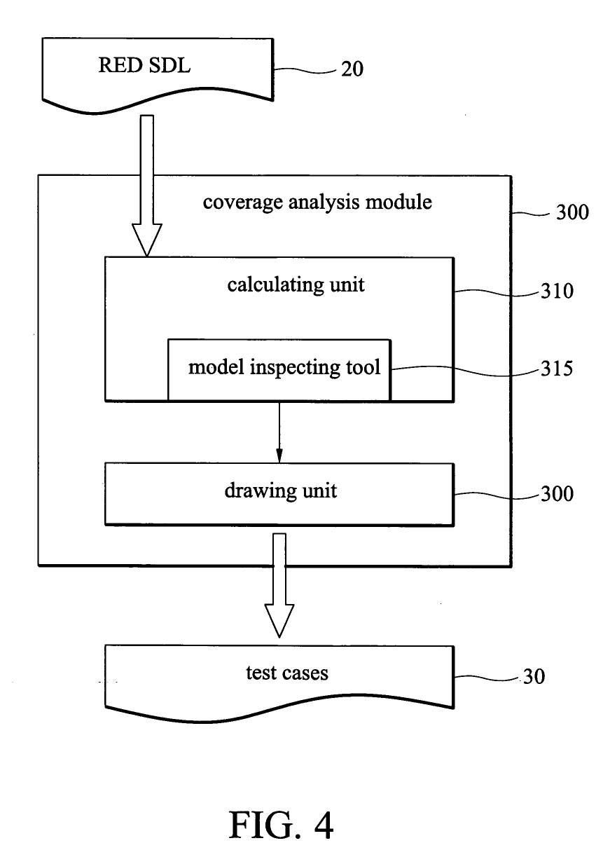

FIG. 4 is a schematic view of an embodiment of coverage analysis module 300 of system 100. Coverage analysis module 300 further comprises a calculating unit 310 and a drawing unit 330. Calculating unit 310 inspects RED SDL 20 using a model inspecting tool 315, implementing verification operations using a coverage analysis algorithm and outputting verification results with a text mode or a graphic interface when the operations are complete. Coverage analysis is to retrieve all applicable test parameters with test cases generated accordingly. Coverage is a ratio of the portion tested (V) in the communication system to the portion to be tested (F) in the communication system, further described in the following.

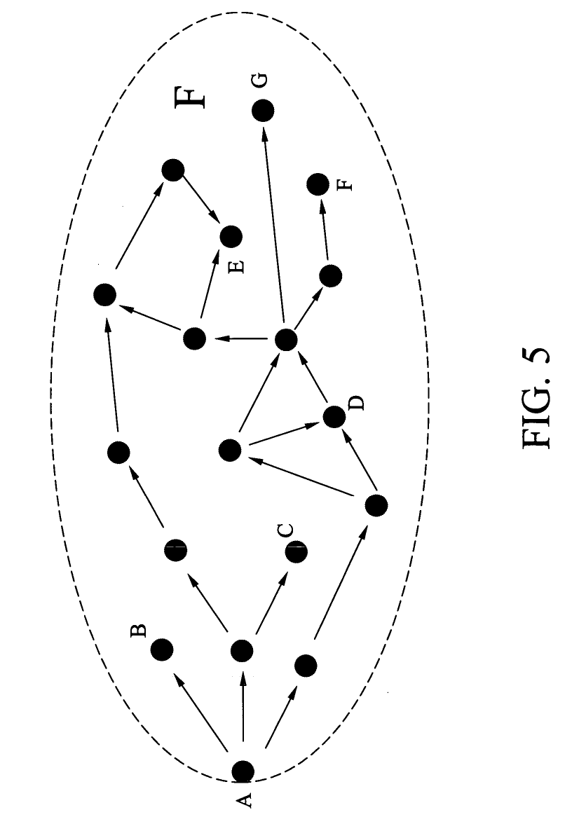

As described above, interactions between SDL modules are represented by a plurality of blocks, each represented as an operation. Referring to FIG. 5, node A indicates an operation (block) from a SDL and arrow signs indicate execution paths from one node (operation) to another. All possible execution paths from node A to each leaf node (node B, C, D, E, F, or G) are shown in FIG. 5, that is to say, indicating the portion to be tested (F) in the communication system. The F is analyzed using the described coverage analysis algorithm according to different parameter settings, thus obtaining the V, indicating optimum test cases applicable to the communication system.

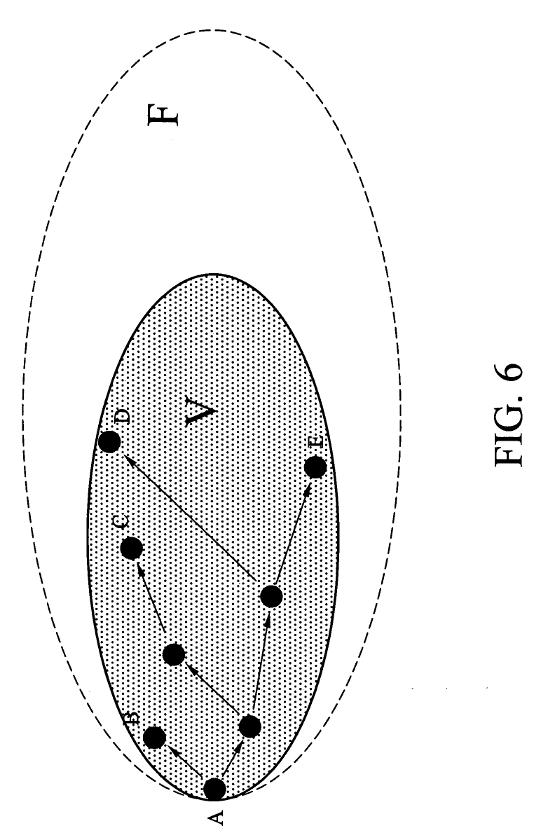

Referring to FIG. 6, showing the coverage analysis result, optimum nodes and execution paths (represented as the gray marked region, indicating the portion tested (V) in the communication system as well) are retrieved. The optimum analysis result is determined based on set parameters, disregarded herein for simplification. Embodiments of the invention utilize three algorithms for estimating coverage, comprising an arc coverage metric (ACM) algorithm, a back-and-forth coverage metric (RCM) algorithm, and a triggering-condition coverage metric (TCM) algorithm. One of the algorithms is selected according to different parameter settings, calculating the V and F values, transmitted to drawing unit 330 to graphically represent the coverage, as shown in FIG. 6.

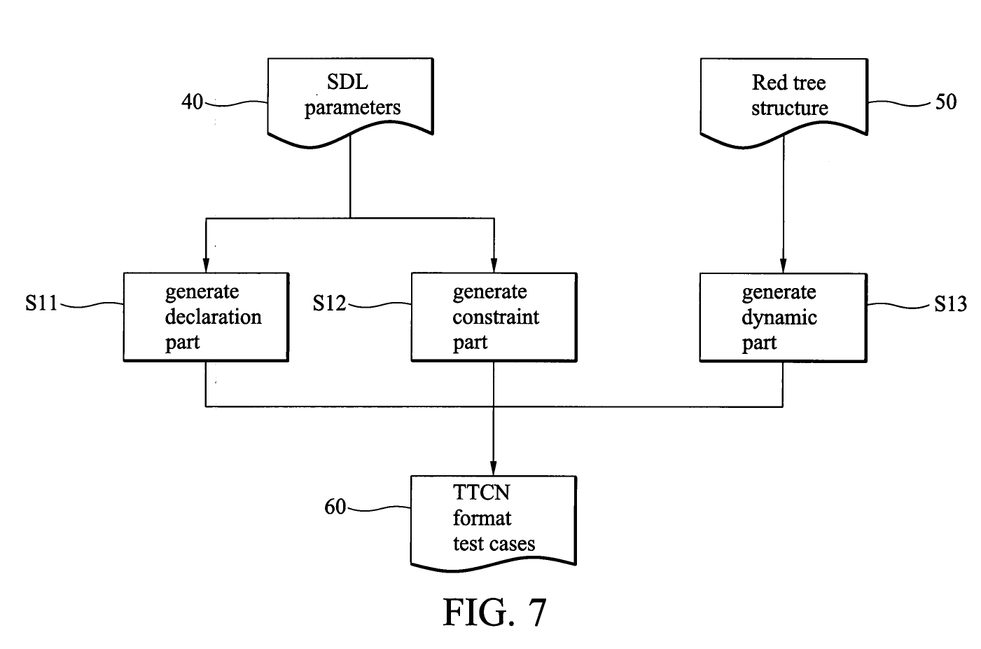

Test-case generation module 400 generates test cases 30, textually or graphically represented, corresponding to SDL 20 according to the verification results. Next, test-case generation module 400 translates test cases 30 to test cases complying with tree and tabular combined notation (TTCN) formats according to a tree structure corresponding to RED SDL 20. A TTCN format test case comprises a declaration part, a constraint part, and a dynamic part. Referring to FIG. 7, a flowchart of an embodiment of generating a TTCN format test case, declaration and constraint parts are generated according to SDL parameters 40 retrieved from source files of RED SDL 20 (steps S11 and S12), the dynamic part is generated according to a tree structure 50 generated using the RED verification tool (steps S13), and the three parts are integrated to generate TTCN format test cases 60.

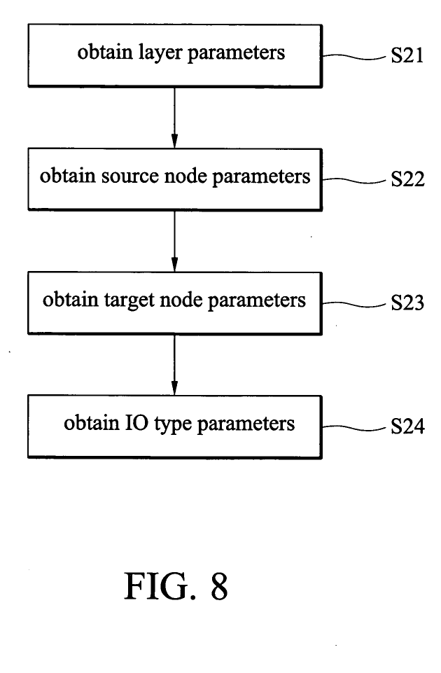

The declaration and constraint parts are unconcerned with the RED verification tool but only quoted, disregarded herein for simplification. The dynamic part comprises parameters consisting of layers, source nodes, destination nodes, and input/output (IO) types, the obtaining procedure thereof described in FIG. 8.

Referring to the coverage analysis shown in FIG. 6, after the RED verification tool implements an analysis process, the execution path from node A to node B indicates a test case, the execution path from node A to node C indicates another, and the like. In the dynamic part, a test case represents a layer, and RED tree structure 50 is expanded to retrieve layers corresponding to all test cases (step S21). Next, source nodes corresponding to all test cases are obtained according to operational states of source automata (not shown) (step S22). Referring to FIG. 6, the source node of a test case represented by the execution path from node A to node C is node A.

Target nodes corresponding to all test cases are obtained according to operational states of target automata (not shown) (step S23). Referring to FIG. 6, the target node of a test case represented by the execution path from node A to node C is node C. Corresponding IO type parameters are obtained according to IO states of the automata (step S24), and, that is to say, an IO operation mode from a source node to a destination node is obtained according to IO types from the process of the automata. Output layers, source nodes, and target nodes correspond to opposite positions in a TTCN format test case. Referring to FIG. 1, TTCN format test cases 500 are translated to programmed executable files (like C programs) 600.

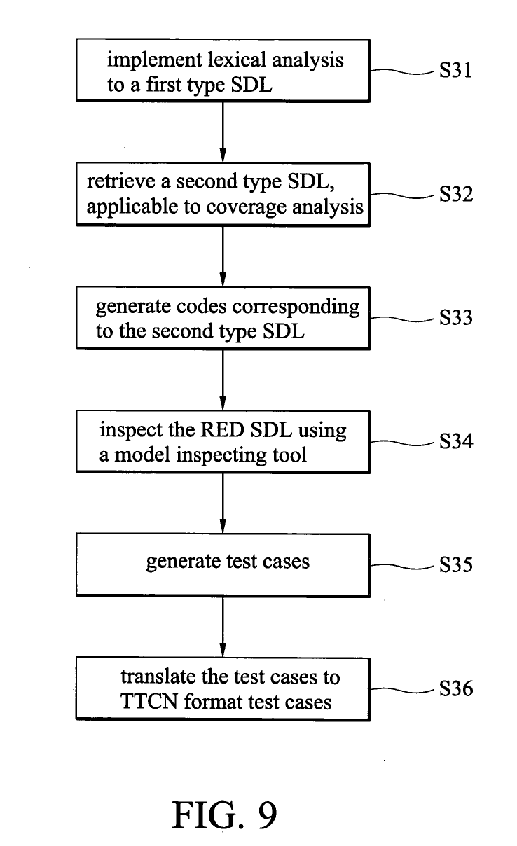

FIG. 9 is a flowchart of an embodiment of a method for automated test-case generation.

Lexical analysis is implemented in a communication system structure designed in accordance with a first type SDL (step S31). A second type SDL, applicable to coverage analysis, is obtained by retrieving information corresponding to the first type SDL according to analysis results (step S32). The second type SDL is translated to state spaces according to translation rules defined using a RED verification tool, such that codes corresponding to the state spaces are generated for storage in a register (step S33). The RED SDL (second type SDL) is inspected using a model inspecting tool (step S34), inspection results are textually or graphically represented, and test cases are generated according to test parameters and the inspection results (step S35). The test cases are translated to TTCN format test cases (step S36).

Embodiments of the invention disclose a system for automated test-case generation, decreasing time and manpower for development and increasing verification accuracy.

Although the present invention has been described in preferred embodiment, it is not intended to limit the invention thereto. Those skilled in this technology can still make various alterations and modifications without departing from the scope and spirit of this invention. Therefore, the scope of the present invention shall be defined and protected by the following claims and their equivalents.

What is claimed is:

1. A system for automated test-case generation, applied to test procedures applied to a communication system designed in accordance with a first type specification and description language (SDL), comprising:
a language translating module, translating the first type SDL to a second type SDL in accordance with translation rules;
a coverage analysis module, analyzing the second type SDL using a coverage analysis algorithm for calculating the coverage of the second type SDL, and generating test cases corresponding to the second type SDL according to the coverage; and
a test-case generation module, generating test cases complying with tree and tabular combined notation (TTCN) formats according to a tree structure corresponding to the second type SDL and TTCNs.

2. The system as claimed in claim 1, wherein the language translating module further comprises:
a lexical analyzer, implementing lexical analysis in the communication system structure designed in accordance with the first type SDL;
a parser, retrieving information corresponding to the first type SDL according to analysis results; and
a code generator, generating the second type SDL according to the translation rules and the analysis results.

3. The system as claimed in claim 2, wherein the second type SDL complies with region-encoding diagram (RED) standards.

4. The system as claimed in claim 2, wherein the translation rules comply with region-encoding diagram (RED) standards.

5. The system as claimed in claim 2, wherein the translation rules define a translation method and the differences between semantics of the first SDL.

6. The system as claimed in claim 1, wherein the coverage analysis module further comprises a calculating unit, inspecting the second type SDL using a model inspecting tool for obtaining the coverage.

7. The system as claimed in claim 6, wherein the coverage is a ratio of the portion tested in the communication system to the portion to be tested in the communication system.

8. The system as claimed in claim 1, wherein a TTCN format test case comprises a declaration part, a constraint part, and a dynamic part.

9. The system as claimed in claim 8, wherein the declaration and constraint parts of the TTCN format test cases are generated according to parameters retrieved from source files of the first type SDL.

10. The system as claimed in claim 8, wherein the dynamic part comprises parameters consisting of layers, source nodes, destination nodes, and input/output (IO) types.

11. The system as claimed in claim 10, wherein the tree structure corresponding to the second type SDL is translated to obtain the parameters.

12. A method for automated test-case generation, applied to test procedures applied to a communication system designed in accordance with a first type specification and description language (SDL), comprising:
translating the first type SDL to a second type SDL in accordance with translation rules;
analyzing the second type SDL using a coverage analysis algorithm for calculating the coverage of the second type SDL, and generating test cases corresponding to the second type SDL according to the coverage; and
generating test cases complying with tree and tabular combined notation (TTCN) formats according to a tree structure corresponding to the second type SDL and TTCNs.

13. The method as claimed in claim 12, further comprising:
implementing lexical analysis in the communication system structure designed in accordance with the first type SDL;
retrieving information corresponding to the first type SDL according to analysis results; and
generating the second type SDL according to the translation rules and the analysis results.

14. The method as claimed in claim 13, wherein the second type SDL complies with region-encoding diagram (RED) standards.

15. The method as claimed in claim 13, wherein the translation rules comply with region-encoding diagram (RED) standards.

16. The method as claimed in claim 13, wherein the translation rules define a translation method and the differences between semantics of the first SDL.

17. The method as claimed in claim 12, wherein the coverage analysis module further comprises a calculating unit, inspecting the second type SDL using a model inspecting tool for obtaining the coverage.

18. The method as claimed in claim 17, wherein the coverage is a ratio of the portion tested in the communication system to the portion to be tested in the communication system.

19. The method as claimed in claim 12, wherein a TTCN format test case comprises a declaration part, a constraint part, and a dynamic part.

20. The method as claimed in claim 19, wherein the declaration and constraint parts of the TTCN format test cases are generated according to parameters retrieved from source files of the first type SDL.

21. The method as claimed in claim 19, wherein the dynamic part comprises parameters consisting of layers, source nodes, destination nodes, and input/output (IO) types.

22. The method as claimed in claim 21, wherein the tree structure corresponding to the second type SDL is translated to obtain the parameters.
